(19) United States
(12) Patent Application Publication
(10) Pub. No.: US 2015/0165443 A1
(43) Pub. Date: Jun. 18, 2015

(54) DRIVE FOR AN ULTRA-HIGH-ENERGY PULSATORY-ROTARY MILL

(71) Applicants: Ryszard Moszumanski, Krakow (PL); Slawomir Knapik, Wola Filipowska (PL); Jerzy Kryza, Krakow (PL); Maciej Moszumanski, Krakow (PL); Krystyna Wieczorek Ciurowa, Krakow (PL)

(72) Inventors: Ryszard Moszumanski, Krakow (PL); Slawomir Knapik, Wola Filipowska (PL); Jerzy Kryza, Krakow (PL); Maciej Moszumanski, Krakow (PL); Krystyna Wieczorek Ciurowa, Krakow (PL)

(73) Assignee: POLITECHNIKA KRAKOWSKA IM. TADEUSZA KOSCIUSZKI, KRAKOW (PL)

(21) Appl. No.: 14/334,409

(22) Filed: Jul. 17, 2014

(30) Foreign Application Priority Data
Dec. 16, 2013 (PL) P.406540

(51) Int. Cl. B02C 17/24; B02C 17/14; B02C 17/08

(52) U.S. Cl. CPC B02C 17/24; B02C 17/08; B02C 17/14

(57) ABSTRACT

The subject of the invention is a drive for an ultra-high-energy pulsatory-rotary mill that can be applied in the laboratory-class equipment.

The objective of the invention is the use of the drive for an ultra-high-energy pulsatory-rotary mill which allows to accomplish the three-dimensional milling process in three axes with simultaneous control of amount of the supplied mechanical energy in real time.

The rotary-planetary drive comprises an alternating-current motor (1) constituting the rotary motion drive and powered through an inverter (2) connected with the rotary mechanical energy counter (3), and an alternating-current motor (4) driving actuator (5) constituting the pulsatory motion drive and powered by inverter (6) connected with the pulsatory mechanical energy counter (7). Signals from mechanical energy counters (7) and (3) are conveyed to the digital recorder (8).

The subject of the present invention is a drive for an ultra-high-energy pulsatory-rotary mill that can be used in laboratory-class apparatus.

Commonly known and widely used ball mills use typically driving solutions employing planetary transmission providing a drive for the sun gear and the vials with the use of a single drive motor. Solutions based on the belt transmission are also used.

Solutions used currently in ball mill drives ensure correct and stable drive for the sun gear and vials in a single plane.

It is not possible to drive milling media in the third axis which would be necessary for carrying out an active three-dimensional milling process.

The objective of the present invention is application of a drive for an ultra-high-energy pulsatory-rotary mill allowing the three-dimensional milling process to be carried out in three axes with simultaneous control of the amount of supplied energy in real time.

The essential idea behind the proposed ultra-high-energy pulsatory-rotary mill drive consists in superposition of two drive types, namely the rotary-planetary drive system and the pulsatory drive system.

A shaft constitutes the rotation axis for the rotary-planetary drive system and at the same time it serves as a means for connection of the pulsatory drive. The shaft is also equipped with a vibro-insulator protecting the pulsatory drive against harmful effects of pulsation. Further, the amount of the supplied mechanical energy is also counted in real time independently for the rotary-planetary drive and the pulsatory drive.

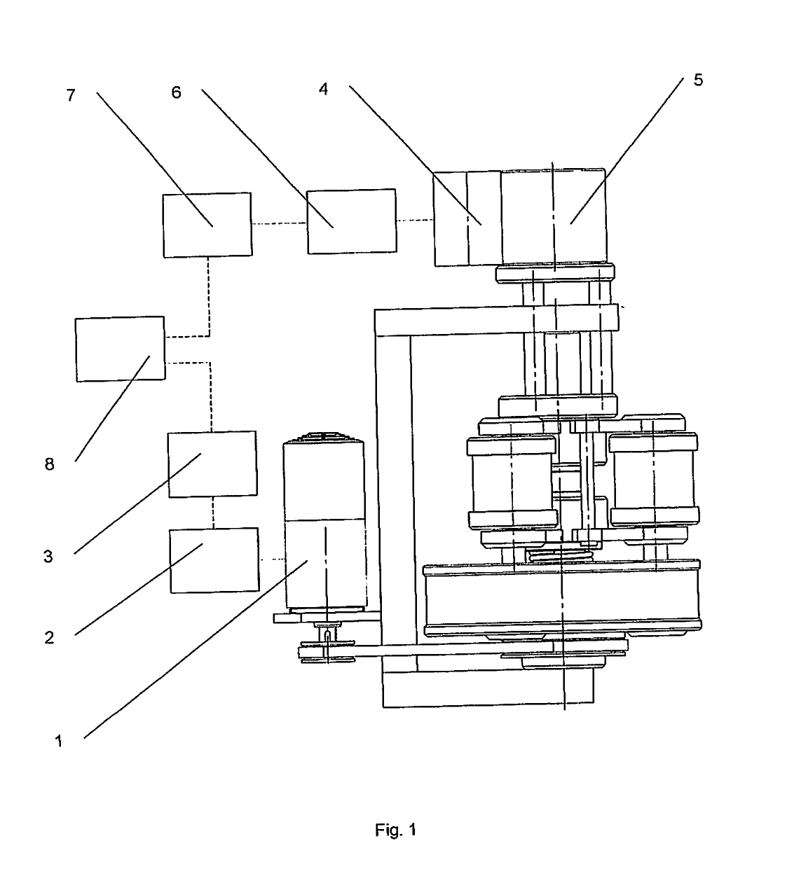

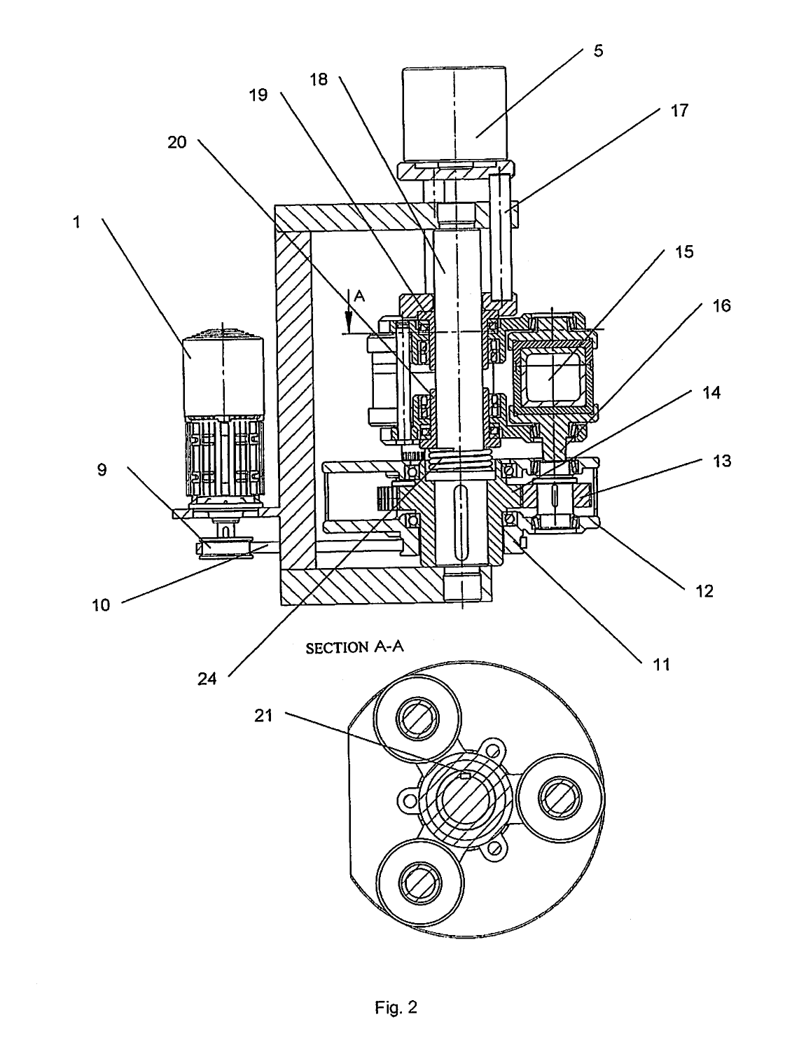

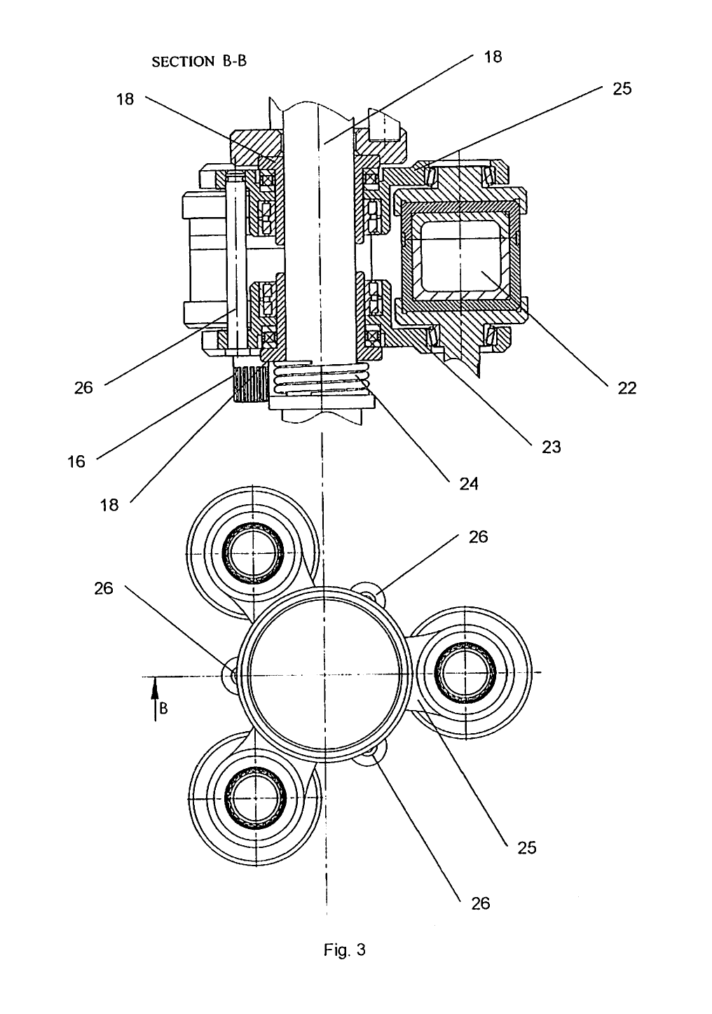

An example embodiment of the invention is shown in FIG. 1, FIG. 2, and FIG. 3.

The rotary-planetary drive comprises an alternating-current motor (1) constituting the rotary drive powered through an inverter (2) and connected with the rotary mechanical energy counter (3), an alternating-current motor (4) driving actuator (5) constituting the pulsatory motion drive, powered through an inverter (6) connected to the pulsatory mechanical energy counter (7). Signals from mechanical energy counters (7) and (3) are conveyed to a digital recorder (8).

A belt pulley (9) mounted on the motor shaft (1) drives a belt pulley (11) secured to the transmission cage (12) by means of a driving belt (10). Planetary gears (13) mounted in the cage revolve about the stationary sun gear (14). The driving torque from planetary gears (13) is transferred onto the assembly of vials (15) by means of a sliding spline joint (16) thus allowing a combination of planetary and pulsatory motion.

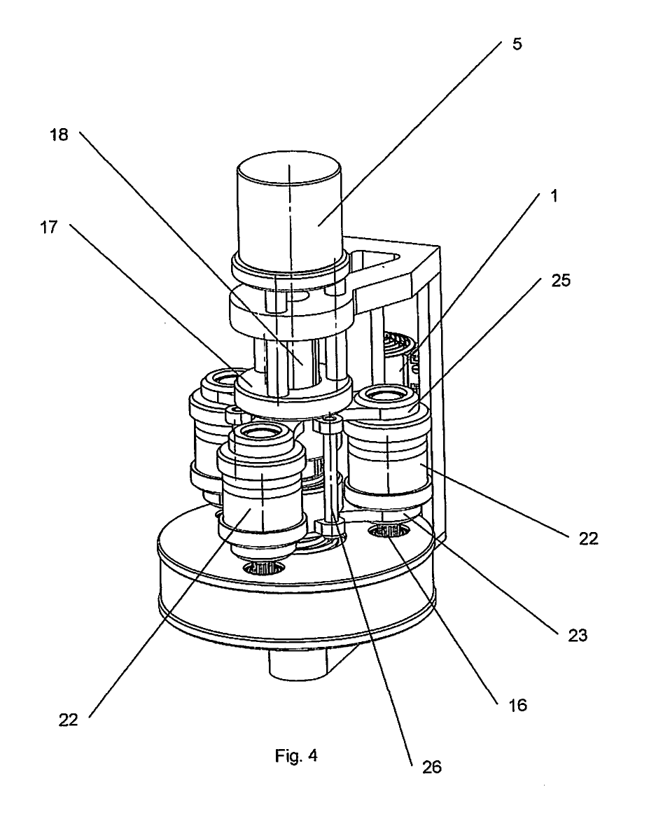

An example of application of the ultra-high-energy pulsatory-rotary mill drive in a complete pulsatory-rotary mill is shown in FIG. 4.

The ultra-high-energy pulsatory-rotary mill drive will find its application in industrial and research laboratories.

The build-in function of counting the amount of the supplied mechanical energy in real time independently for the rotary-planetary drive and the pulsatory drive will find its application in the complete pulsatory-rotary mill energy balancing process.

1. A drive for an ultra-high-energy pulsatory-rotary mill characterised in that it has the functionality of superposition of two drive types, the rotary drive and the pulsatory drive, accomplished by transferring the torque from planetary gears (13) onto the assembly of vials (15) via a sliding spline joint (16).

2. A drive for an ultra-high-energy pulsatory-rotary mill according to claim 1 characterised in that the pulsatory drive comprises a vibration actuator (5) located on the pressure table (17) mounted slidably on shaft (18) and connected with the assembly of vials (15) by means of an upper slide sleeve (19) and a lower slide sleeve (20), while the slide sleeves (19) and (20) are protected against rotation with respect to the shaft (18) by means of a key slot (21), whereas the assembly of vials (15) comprises vials (22) mounted between the lower rotary cage (23) constituting a mounting for vibro-insulator (24) and an elevated upper cage (25) protected against opening in the course of operation of the mill by means of ties (26).

3. A drive for an ultra-high-energy pulsatory-rotary mill according to claim I characterised in that the amount of mechanical energy supplied by the drive is counted and recorded in real time independently for the rotary-planetary drive and the pulsatory drive, whereas the functionality is realised by means of conveying respective signals from the inverter (2) to the mechanical rotational energy counter (3), transmitting respective signals from inverter (6) to the mechanical pulsatory energy counter (7), and leading output signals from the mechanical rotary energy counter (3) and the mechanical pulsatory energy counter (7) to input terminals of a digital recorder (8).
